(19) United States
(12) Patent Application Publication
(10) Pub. No.: US 2009/0063860 A1
(43) Pub. Date: Mar. 5, 2009

(54) Printer driver that encrypts print data

(76) Inventors: Albert Tyler Barnett, Georgetown, KY (US); David Zachery Lindsey, Paris, KY (US); Kenneth Ross Wilkerson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/897,983

(22) Filed: Aug. 31, 2007

(51) Int. Cl. H04L 9/14

(52) U.S. Cl. 713/171

(57) ABSTRACT

A system for transmitting encrypted print job data across a network. The printer driver on the client device encrypts the print job data using a random AES key and uses the printer's public key to encrypt the random AES key. The print job data remains encrypted during transmission from the client device to the printer via the server. As such, the contents of the print job cannot be viewed by anyone who eavesdrops on the communications between the client device and the printer or by anyone who obtains the print job data from the server's data storage medium. The printer's public certificate, containing the printer's public key, is promulgated to the client device via the server which stores the printer's public certificate with other data pertinent to the client device's printer driver.

### BACKGROUND OF THE INVENTION

This invention relates generally to the field of networked printer systems and, in particular, to the field of networked printer systems that provide for secure transmission of print data across a network from a client device to a printer. More particularly, the invention relates to a printer driver that encrypts print data to provide end-to-end, client-to-printer, encryption for print data.

Printers are typically connected to a client device either directly or via a server. Where a printer is directly connected to client device, prior art systems permit encryption of print data sent from the client to the directly-connected printer. The use of a server is often advantageous over a directly-connected printer because it provides the ability to connect multiple client devices to one or more printers. Some networked printer systems utilize encryption to prevent the unauthorized viewing of the contents of print jobs.

In a client/server printing network environment, prior art print job encryption systems transmit the unencrypted print job from the client device to the server. The server then encrypts the print job and forwards it to the printer. Thus, anyone eavesdropping on the communications between the client device and the printer or anyone with access to the unencrypted print queue on the server can view the contents of the print jobs. These vulnerabilities are particularly relevant where the print jobs must be transmitted over an insecure network and where the server administrator is not authorized to view the contents of the print jobs.

### BRIEF SUMMARY OF THE INVENTION

Embodiments of the present invention provide a system for transmitting encrypted print job data across a network. The printer driver on the client device encrypts the print job data using a random AES key and uses the printer's public key to encrypt the random AES key. The print job data remains encrypted during transmission from the client device to the printer via the server. As such, the contents of the print job cannot be viewed by anyone who eavesdrops on the communications between the client device and the printer or by anyone who obtains the print job data from the server's data storage medium. The printer's public certificate, including the printer's public key, is promulgated to the client device via the server which stores the printer's public certificate with other data pertinent to the client device's printer driver.

In a first aspect of the present invention, a system may include an output device (such as a printer) including an output device cryptographic module; a client (such as a computer terminal) including a client output device driver having a client device cryptographic module; and a server operatively interposed between the client device and the output device on a network; such that the output device cryptographic module generates a first key and transmits the first key to the server, the server transmits the first key to the client device cryptographic module, the client device cryptographic module generates a second key and encrypts data using the second key, the client device cryptographic module encrypts the second key using the first key, the client device transmits the encrypted data and the encrypted second key to the output device cryptographic module via the server, the output device cryptographic module decrypts the encrypted second key and the encrypted data, and the output device produces an output corresponding to the data. It is within the scope of the invention to omit the use of the second key and to utilize only the first key of the above-described system. In such an alternative embodiment, the client device encrypts the data using the first key and transmits the encrypted data to the output device cryptographic module via the server.

In a detailed embodiment of the first aspect, the first key may be a public key of a public-private key pair and the second key may be a symmetric key. The client device may receive the client output device driver from the server via the network. The client device may receive an updated client output device driver from the server via the network if the updated client output device driver is available on the server but has not yet been installed on the client device. The updated client output device driver may include an updated first key. The output device may be a printer, the server may be a print server, and the client output device driver may be a printer driver.

In a second aspect of the present invention, a client output device driver may include a rendering component; a client device cryptographic module operatively connected to receive data from the rendering component; and a user interface operatively connected to the cryptographic component.

In a detailed embodiment of the second aspect, the client device cryptographic module may include a key generator adapted to generate a symmetric key and a data encryption component adapted to encrypt data using the symmetric key and to encrypt the symmetric key using a public key. The client output device driver may be a printer driver. The client output device driver may be installed on a client device and the client device may be operatively connected to an output device via a network. The output device may include an output device cryptographic module adapted to decrypt data encrypted by the client device cryptographic module. The output device cryptographic module may provide the public key to the client device cryptographic module via the network.

In a third aspect of the present invention, a method for securely transmitting an output device job may include the steps of: providing an output device including an output device cryptographic module; providing a client device including a client output device driver having a client device cryptographic module; providing a server which may be operatively interposed between the client and the output device on a network; generating a first key using the output device cryptographic module; transmitting the first key from the output device to the server via the network; transmitting the first key from the server to the client device; generating a second key on the client device cryptographic module; encrypting output data using the second key on the client device cryptographic module; encrypting the second key using the first key on the client device cryptographic module; transmitting the encrypted data and the encrypted second key from the client device to the output device cryptographic module via the server; decrypting the encrypted second key and the encrypted output data on the output device cryptographic module; and producing an output corresponding to the decrypted output data using the output device. The first key may be a public key of a public-private key pair and the second key may be a symmetric key. The step of providing the client device may include transmitting the client output device driver including the client device cryptographic module from the server to the client device. The method may further include the step of transmitting, from the server to the client device via the network, an updated client output device driver if the updated client output device driver is available on the server but has not yet been installed on the client device. The updated client output device driver may include an updated public key. The output device may be a printer, the server may be a print server, and the client output device driver may be a printer driver.

In a fourth aspect of the present invention, a method for securely transmitting data to an output device may include the steps of: providing a client device, a server, and an output device operatively interconnected on a network; storing, on the server, a client output device driver; transmitting a public key of the output device to the server; storing the public key of the output device on the server; transmitting from the server to the client device, upon request by the client device, the client output device driver; transmitting from the server to the client device, upon request by the client device, the public key of the output device; encrypting an output device job on the client device using a symmetric key; encrypting the symmetric key on the client device using the public key; transmitting the encrypted output device job and the encrypted symmetric key from the client device to the output device via the server; decrypting, on the output device, the encrypted symmetric key using a private key corresponding to the public key; decrypting the encrypted output device job using the decrypted symmetric key; and producing an output by the output device corresponding to the decrypted output device job.

The method may further include the steps of transmitting an updated public key from the output device to the server; storing the updated public key on the server; and transmitting, upon request by the client device, the updated public key from the server to the client device. Additionally, the method may further include the step of generating the public key using the output device. Further, the method may include the step of generating the symmetric key using the client device. The output device may be a printer.

In a fifth aspect of the present invention, a system may include an output device having an output device cryptographic module; a client device including a client device output device driver having a client device cryptographic module; and a server operatively interposed between the client device and the output device on a network. The output device cryptographic module may include means for generating a first key and/or means for transmitting the first key to the server. The server may include means for transmitting the first key to the client device cryptographic module. The client device cryptographic module may include means for generating a second key, means for encrypting data using the second key, and/or means for encrypting the second key using the first key. The client device may include means for transmitting the encrypted data and the encrypted second key to the output device cryptographic module via the server. The output device cryptographic module may include means for decrypting the encrypted second key and the encrypted data. The output device may include means for producing an output corresponding to the data.

These and other aspects and advantages of the present invention will become apparent to those skilled in the art upon consideration of the following detailed description of exemplary embodiments exemplifying of the invention as presently perceived.

### BRIEF DESCRIPTION OF THE SEVERAL VIEWS OF THE DRAWINGS

The detailed description particularly refers to the accompanying Figures in which:

FIG. 1 is a functional schematic representation of an exemplary embodiment of the present invention showing the transmission path of a cryptographic key and the transmission path of encrypted print job data;

FIG. 2 is a schematic representation of a networked printer system including data storage devices;

FIG. 3 is a detailed functional schematic representation of a client according to an exemplary embodiment of the present invention;

FIG. 4 is a detailed functional schematic representation of a server according to an exemplary embodiment of the present invention;

FIG. 5 is a detailed functional schematic representation of a printer according to an exemplary embodiment of the present invention; and

FIG. 6 is a screen capture of an exemplary embodiment of a printer driver user interface on a server.

### DETAILED DESCRIPTION OF THE INVENTION

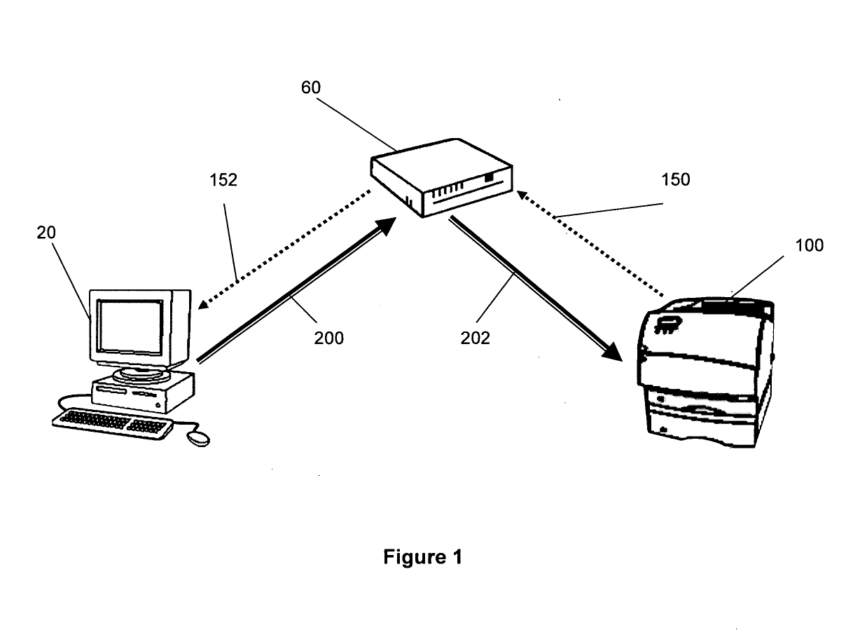

FIG. 1 depicts an exemplary embodiment of the present invention including an interconnected (via a computer network or any other data network(s) or link(s) as is known to those of ordinary skill) client device 20, server 60, and output device 100. As described in detail below, the output device 100 (such as a printer) transmits a cryptographic key to the client device 20 (such as a user computer) via cleartext output device-server path 150 and cleartext server-client path 152. The client device 20 encrypts an output device job and transmits the encrypted job to the output device 100 via encrypted client-server path 200 and encrypted server-output device path 202. The output device 100 decrypts the job and produces the desired output. Thus, the output device job is encrypted from its origin at the client device 20 to its destination at the output device 100.

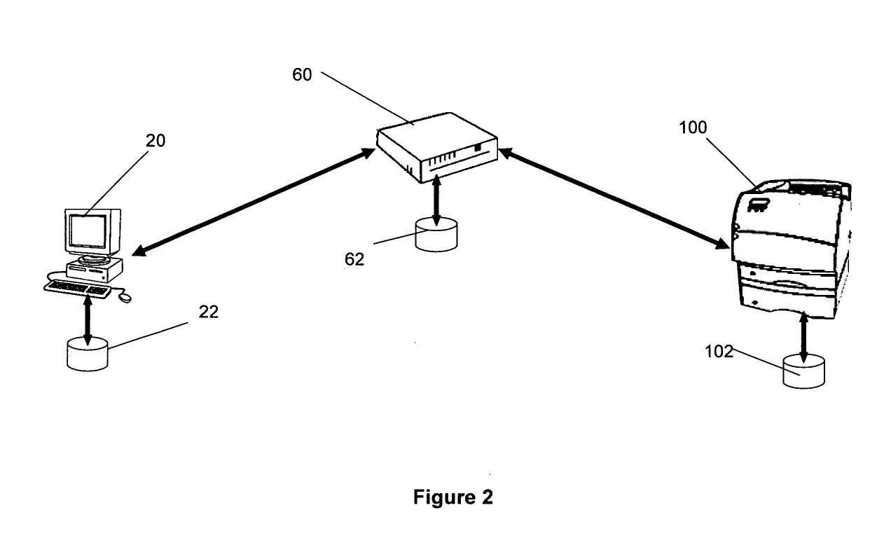

Turning to FIG. 2, each of the client device 20, server 60, and output device 100 may have its own data storage medium 22, 62, 102. Because the output device job data is encrypted prior to transmission from the client device 20, the output device job data is not available in decrypted form to anyone intercepting the data anywhere between the client device 20 and the output device 100. In particular, the output device job data is not available in decrypted form on the server 60 or on the server's storage medium 62. Thus, the contents of the output device job are protected from viewing by anyone who intercepts the data during transmission and the contents of the output device job are also protected from viewing by anyone with access to the data storage medium 62 on the server 60, such as the server administrator.

Security at the client device 20 is addressed by customary client device security measures. These measures provide security for the client device 20 as well as its data storage medium 22. Security of the output device data storage medium 102 is typically provided by existing output device security measures. Accordingly, these security measures, in conjunction with the present invention, provide end-to-end protection against unauthorized viewing of the contents of the output device job. In short, by providing a system that encrypts the output job before it is spooled to the server 60, by merely gaining access the server 60 an individual is not able view unencrypted output job data.

As used herein, the term “network” refers to one or more connections between devices using wired, wireless, fiber optic, or other electronic communications technologies. The present invention merely requires data connections between the client device 20 and the server 60 as well as the server 60 and the output device 100; no particular technology nor network configuration is implied. In addition, the network may include multiple interconnections between a plurality of client devices, servers, and output devices. It is also within the scope of the invention that the server 60 include one or more server devices or systems of computerized devices; and it is even within the scope of certain aspects of the present invention that the server 60 reside either partially or wholly on the client device 20 and/or the output device 100. Also, as used herein, the terms “component” and “module” (such as “cryptographic module”) may refer to hardware, software, or any combination thereof.

In an exemplary embodiment, the client device 20 is a conventional desktop personal computer running a MICROSOFT WINDOWS® operating system (WINDOWS® 2000 or later). The server 60 is a server running MICROSOFT WINDOWS® 2000 Server or WINDOWS SERVER® 2003, including the Microsoft “Point and Print” feature. The output device 100 is a printer (mono-color, color, or multi-function device) including an installed LEXMARK PRINTCRYPTION™ card. These devices are interconnected on a TCP/IP network. Accordingly, the description of the exemplary embodiment includes details specific to these devices. It is within the scope of the invention, however, to utilize other hardware and software, including, but not limited to, different client devices, servers, operating systems, output devices (such as, but not limited to, display devices, audio devices, and any type of printer, including dot matrix, inkjet, laser, thermal, and LED), networks, and encryption algorithms (such as, but not limited to, DES, 3DES, SHA1, Serpent, Twofish, RC6, and MARS), and encryption devices. In addition, it is within the scope of the invention to utilize other encryption schemes, such as, but not limited to, purely asymmetric key exchange for all transactions or the transmission of symmetric keys. It is to be understood that the cryptographic keys discussed herein may be included in cryptographic certificates. For example, the printer's public key may be included in the printer's public certificate which may be transmitted to the client device 20 via the server 60.

The exemplary embodiment utilizes public key infrastructure (“PKI”) cryptography. The LEXMARK PRINTCRYPTION™ card installed in the printer includes a pseudorandom number generator (“PRNG”) that produces a 1024 bit RSA public key (in the form of a self-signed X.509 certificate) and a corresponding 1024 bit RSA private key. These keys do not change unless the cryptographic module is removed from the printer or the key is intentionally regenerated.

As described in greater detail below, the printer 100 transmits the public key to the server 60 and the server 60 forwards the public key to the client device 20. The client device 20 uses a PRNG to generate an ephemeral 128, 192, or 256 bit session key, which it uses to encrypt the print job using the Advanced Encryption Standard (“AES”) Rijndael algorithm in either the electronic code book (“ECB”) or the cipher block cipher (“CBC”) mode with a block length of 128 bits. The client device 20 encrypts the session key using the public key. The encrypted session key is prepended to the encrypted print job and is referred to as the session key header (“SKH”). The client device 20 then transmits the SKH and encrypted print job to the printer 100. The printer 100 decrypts the SKH using its previously-generated private key, then it decrypts the print job using the session key.

In addition to the SKH, each encrypted print job also contains a universal exit language (“UEL”) command prior to the beginning of the actual print job data. Because the UEL command is a particular 9 byte series, it is used by the printer 100 to verify proper decryption of the print job. Essentially, if the decrypted print data does not begin with the UEL command, the printer 100 deletes the job and nothing is printed. This situation could arise if an unencrypted print job was sent to the encrypted printer port, a print job was encrypted using the wrong public key, or another printer on the same network was illegally using the same IP address.

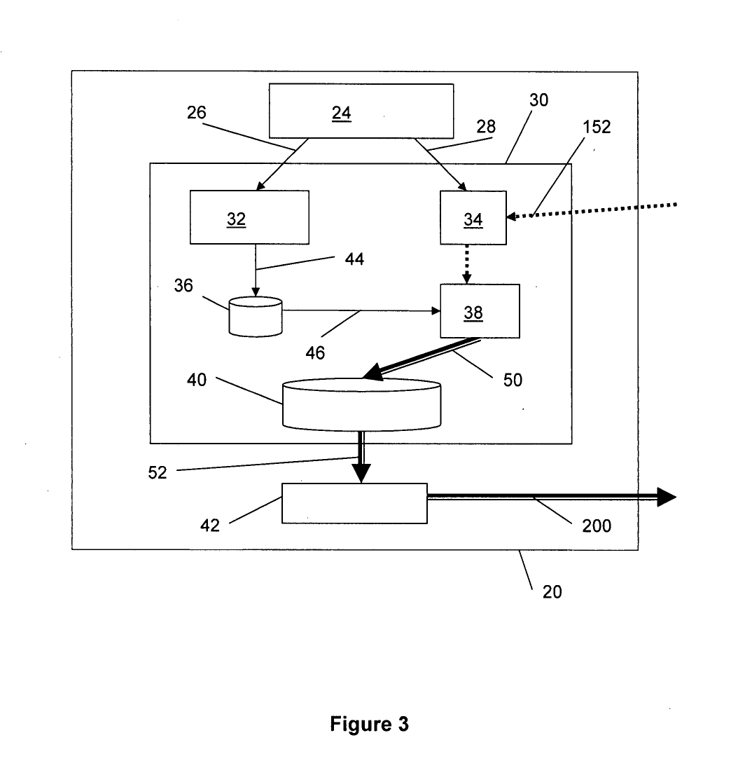

FIGS. 3-5 depict the various components and communication paths of the exemplary embodiment of the present invention. FIG. 3 is a detailed functional schematic diagram of the client device 20 of the exemplary embodiment. Client device 20 includes an application 24 which produces a print job comprising data. For example, the application may be a word processing program or an image editor and the print job may include a page description language document. Other types of print jobs will be known to those of ordinary skill in the art. Application 24 communicates with an output device driver 30, which is a printer driver in the exemplary embodiment, using MICROSOFT WINDOWS® API calls as an intermediary. The printer driver 30 includes a rendering component 32, a user interface 34, and a cryptographic component 38. Client device 20 also includes a spooler 42, which receives print jobs from the printer driver 30 and transmits the print jobs to the server 60.

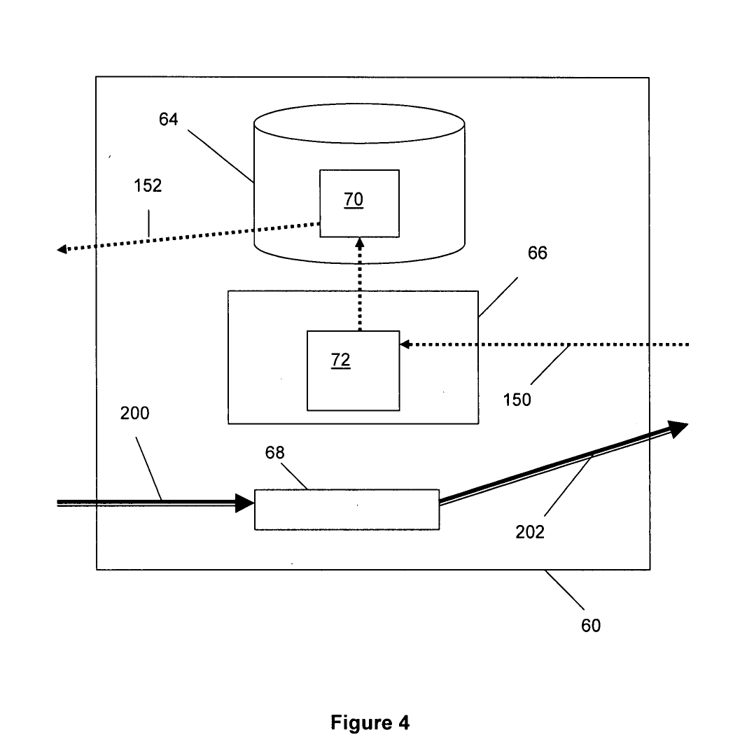

FIG. 4 is a detailed functional schematic diagram of server 60 of the exemplary embodiment. Server 60 includes a registry 64, a printer driver 66, and a spooler 68. As discussed below, the server 60 includes the client's printer driver which is transmitted to the client device 20. The server's printer driver 66 performs conventional print server functions and also includes a cryptographic key retrieval function 72, through which the server queries the output device 100 for its cryptographic key. The server printer driver 66 stores the cryptographic key at a location 70 in the registry 64 for subsequent transmission to the client device 20. It is within the scope of the invention for the server 60 to store the key in another location, such as RAM, or using another data storage means.

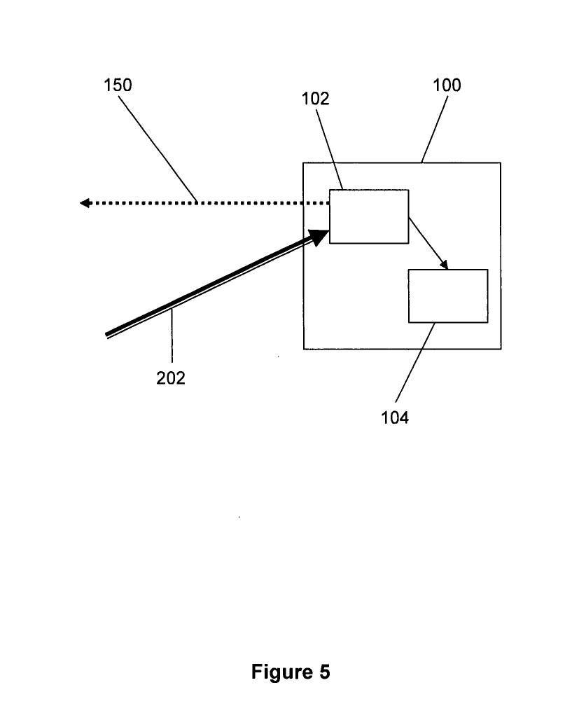

FIG. 5 depicts a printer 100 with a cryptographic module 102 and a print device 104. The cryptographic module 102 transmits the cryptographic key via path 150 and receives the encrypted print job data via path 202. The cryptographic module 102 sends decrypted print jobs to the print device 104 for printing. In the exemplary embodiment, network communications pertaining to the public key occur on port 9150 and the encrypted print job is received on port 9152.

The following sequence of events occurs when a client device 20 initiates a print job. First, the client device 20 establishes a connection to the printer 100 via the MICROSOFT WINDOWS® “Point and Print” feature. In essence, this feature provides for the automatic download and installation onto the client device 20 of all printer driver 30, data, and configuration files necessary to send jobs to the printer 100. The server 60 stores these files and makes them available to client devices 20. If, when a user desires to print to a particular printer 100, the appropriate printer driver 30 is not already installed on the client device 20, the client device 20 downloads the driver 30 from the server 20 and installs it. In the exemplary embodiment, this is accomplished using the MICROSOFT WINDOWS® “Add Printer Wizard” feature. Additionally, even if an appropriate printer driver 30 is already installed on the client device 20, the client device 20 automatically communicates with the server 60 to determine whether an updated printer driver 30 is available on the server 60. If an updated driver 30 is available, the client device 20 automatically downloads and installs the updated printer driver 30.

Once the printer driver 30 is installed on the client device 20, the printer driver 30 queries the server's “PrinterDriverData” registry area 70 in the installed options table to obtain the printer's public key. The rendering module 32 of the printer driver 30 performs all necessary rendering of the print job, producing a RAW print job stored in unencrypted buffer 36. The RAW print job is provided to the cryptographic component along with the printer's public key, which is supplied via the user interface 34. The cryptographic component 38 encrypts the data and delivers it to encrypted buffer 40. It is within the scope of the invention for the cryptographic component to receive the RAW print job either as it is rendered or all at once after the rendering is complete. The printer driver 30 sends the encrypted buffer 40 to the print server 60 via the spooler 42 as a RAW print job, thus indicating that no processing by the server 60 is required. The print server 60 spools the encrypted print job to the printer 100 using spooler 68. The cryptographic module 102 decrypts the print job data and the printer 100 prints the job using print device 104.

In FIGS. 3-5, the path of the printer's public key is shown with dashed lines. As described above, the public key is generated in the cryptographic module 102. The server's printer driver 66 obtains the public key over path 150 and stores the key in the server's registry 64 at location 70. Upon initiation of a print job, the user interface 34 of the client's printer driver 30 receives the public key from the server over path 152, if the client device 20 does not already have the current public key. The user interface 34 passes the public key to the cryptographic module 38 for use in encrypting the print job.

Application 24 transmits unencrypted print commands to the printer driver 30 over paths 26, 28. Data pertaining to the graphics to be printed are transmitted over path 26 to the rendering component 32. Whenever the printer driver 30 is invoked on the client device 20 via path 28, the printer driver 30 checks if an updated version of the printer driver 30 exists on the server 60, and if so, the updated printer driver 30 is pulled down from the server 60. The rendering component 32 transmits the RAW unencrypted print data to the cryptographic component 38 over paths 44, 46 via unencrypted buffer 36.

The encrypted print job travels over paths 52, 200, and 202 to the client spooler 42, server spooler 68, and to the cryptographic module 102 in the printer 100. Finally, the decrypted print job is transmitted to the print device 104.

Although print server systems typically permit either the client device 20 or the server 60 to render print jobs, the printer driver 30 of the exemplary embodiment performs all of the required rendering. As such, the printer driver 30 spools all print jobs as RAW print jobs. This is because the server 60 is not able to access the contents of the encrypted print jobs due to the encryption and, therefore, the server 60 cannot perform any data manipulation in this exemplary embodiment.

Unencrypted or encrypted metadata corresponding to the encrypted print data may be generated prior to the encryption of the print job. For example, metadata pertaining to various print job attributes may be used by a managed print services system for billing and services purposes. Such metadata may include job identification number, originating computer, job name, originating user, copies, pages, N-up (printing more than one logical page on a physical page), duplex, color, bytes printed, job time, queue, port name, host name, serial number, model, IP address, paper type, paper size, scan type, pages scanned, original media size, collated, destinations, MAC address, and data source. The metadata may be appended or prepended to the encrypted print job or the metadata may be transmitted separately from the encrypted print job.

In the exemplary embodiment, the server's printer driver 66 is initially installed using software contained on a portable memory device such as a compact disk or a flash drive. It is within the scope of the invention to utilize other means of installing the server printer driver 66 including, but not limited to, transmission via the network. Additionally, the server 60 obtains the public key from the printer 100 via path 150. The printer driver 66 places the public key into the appropriate location 70 in the registry 64. In the exemplary embodiment, the server printer driver 66 and the client printer driver 30 comprise the same software; the client printer driver 30 is merely a copy of the server printer driver 66.

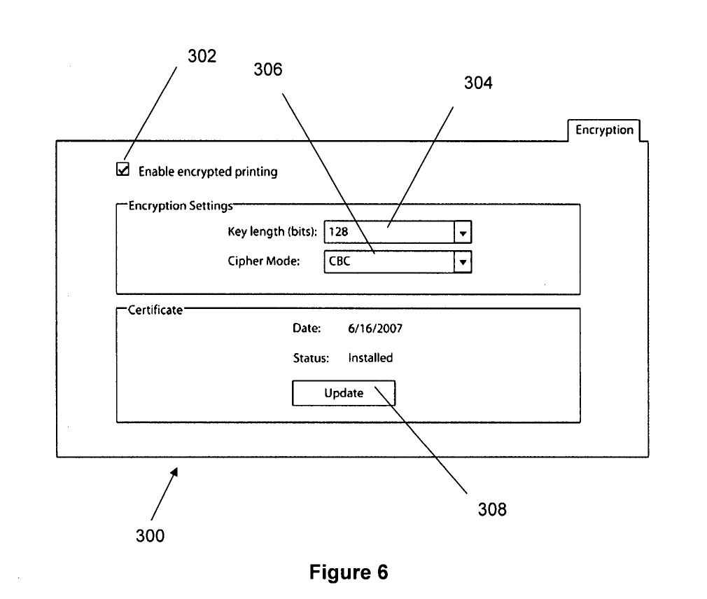

FIG. 6 is a screen shot of an “Encryption” tab 300 in the properties dialog of a print server 60 of an exemplary embodiment of the present invention. Check box 302 is checked to enable encrypted printing. The sever administrator may set the key length and AES mode using drop down menus 304, 306. Additionally, the server administrator may manually refresh the server's copy of the printer's public key by selecting the update button 308. This tab 300 appears in the properties dialog in addition to the other normally-present tabs.

While exemplary embodiments of the invention have been set forth above for the purpose of disclosure, modifications of the disclosed embodiments of the invention as well as other embodiments thereof may occur to those skilled in the art. Accordingly, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the stated advantages or objects of the invention disclosed herein to fall within the scope of the claims, since inherent and/or unforeseen advantages of the present invention may exist even though they may not have been explicitly discussed herein.

What is claimed is:

1. A system for securely transmitting an output device job, comprising:
an output device including an output device cryptographic module;
a client device, the client device including a client output device driver having a client device cryptographic module; and
a server operatively interposed between the client device and the output device on a network;
wherein the output device cryptographic module is configured to generate a first key and to transmit the first key to the server, the server is configured to transmit the first key to the client device cryptographic module, the client device cryptographic module is configured to encrypt a first set of data using the first key, the client device is configured to transmit the encrypted first set of data to the output device cryptographic module via the server, and the output device cryptographic module is configured to decrypt the encrypted first set of data.

2. The system of claim 1, wherein the client device cryptographic module is configured to generate the first set of data comprising a second key, to encrypt a second set of data using the second key, and to transmit the encrypted second set of data to the output device cryptographic module via the server;
wherein the output device cryptographic module is configured to decrypt the encrypted second set of data using the second key; and
wherein the first key is a public key of a public-private key pair and the second key is a symmetric key.

3. The system of claim 2, wherein the client device is configured to receive the client output device driver from the server via the network.

4. The system of claim 3, wherein the client device is configured to receive an updated client output device driver from the server via the network if the updated client output device driver is available on the server but has not yet been installed on the client device.

5. The system of claim 4, wherein the updated client output device driver includes an updated first key.

6. The system of claim 1, wherein the output device is a printer, the server is a print server, and the client output device driver is a printer driver.

7. A client output device driver, comprising:
a rendering component;
a client device cryptographic module operatively connected to receive data from the rendering component; and
a user interface operatively connected to the client device cryptographic module.

8. The client output device driver of claim 7, wherein the client device cryptographic module comprises a key generator adapted to generate a symmetric key and a data encryption component adapted to encrypt data using the symmetric key and to encrypt the symmetric key using a public key.

9. The output device driver of claim 7, wherein the client output device driver is a printer driver.

10. The client output device driver of claim 7, wherein the client output device driver is installed on a client device and the client device is operatively connected to an output device via a network.

11. The output device driver of claim 10, wherein the output device includes an output device cryptographic module adapted to decrypt data encrypted by the client device cryptographic module.

12. The output device driver of claim 11, wherein the output device cryptographic module is configured to provide the public key to the client device cryptographic module via the network.

13. A method of securely transmitting an output device job, comprising the steps of:
providing an output device, the output device including an output device cryptographic module;
providing a client device, the client device including a client output device driver having a client device cryptographic module;
providing a server, the server being operatively interposed between the client device and the output device on a network;
generating a first key using the output device cryptographic module;
transmitting the first key from the output device to the server via the network;
transmitting the first key from the server to the client device;
generating a second key on the client device cryptographic module;
encrypting output data using the second key on the client device cryptographic module;
encrypting the second key using the first key on the client device cryptographic module;
transmitting the encrypted data and the encrypted second key from the client device to the output device cryptographic module via the server;
decrypting the encrypted second key and the encrypted output data on the output device cryptographic module; and
producing an output corresponding to the decrypted output data using the output device.

14. The method of claim 13, wherein the first key is a public key of a public-private key pair and the second key is a symmetric key.

15. The method of claim 14, wherein the step of providing a client device includes transmitting the client output device driver including the client device cryptographic module from the server to the client device.

16. The method of claim 15, further comprising the step of transmitting, from the server to the client device via the network, an updated client output device driver if the updated client output device driver is available on the server but has not yet been installed on the client device.

17. The method of claim 16, wherein the updated client output device driver includes an updated public key.

18. The method of claim 13, wherein the output device is a printer, the server is a print server, and the client output device driver is a printer driver.

19. The method of claim 13, further comprising the step of generating metadata corresponding to the output data.

20. A method of securely transmitting data to a printer, comprising the steps of:
providing a client device, a server, and a printer operatively interconnected on a network;
storing, on the server, a printer driver;
transmitting a public key of the printer to the server;
storing the public key of the printer on the server;
transmitting from the server to the client device, upon request by the client device, the client printer driver;
transmitting from the server to the client device, upon request by the client device, the public key of the printer;
encrypting a print job on the client device using a symmetric key;
encrypting the symmetric key on the client device using the public key;
transmitting the encrypted print job and the encrypted symmetric key from the client device to the printer via the server;
decrypting, on the printer, the encrypted symmetric key using a private key corresponding to the public key;
decrypting the encrypted print job using the decrypted symmetric key; and
printing output by the printer corresponding to the decrypted print job.

21. The method of claim 20, further comprising the steps of:
transmitting an updated public key from the printer to the server;
storing the updated public key on the server; and
transmitting, upon request by the client device, the updated public key from the server to the client device.

22. The method of claim 21, further comprising the step of generating the public key using the printer.

23. The method of claim 22, further comprising the step of generating the symmetric key using the client device.

24. The method of claim 20, further comprising the step of generating unencrypted metadata corresponding to the print job; wherein the metadata includes one or more of the group consisting of: job identification number, originating computer, job name, originating user, copies, pages, N-up, duplex, color, bytes printed, job time, queue, port name, host name, serial number, model, IP address, paper type, paper size, scan type, pages scanned, original media size, collated, destinations, MAC address, and data source.

25. A system for securely transmitting an output device job, comprising:
an output device including an output device cryptographic module;
a client device, the client device including a client device output device driver having a client device cryptographic module; and
a server operatively interposed between the client device and the output device on a network;
wherein the output device cryptographic module includes means for generating a first key and means for transmitting the first key to the server; the server includes means for transmitting the first key to the client device cryptographic module; the client device cryptographic module includes means for generating a second key, means for encrypting data using the second key, and means for encrypting the second key using the first key; the client device includes means for transmitting the encrypted data and the encrypted second key to the output device cryptographic module via the server; the output device cryptographic module includes means for decrypting the encrypted second key and the encrypted data; and the output device includes means for producing an output corresponding to the data.
